(19) United States
(12) Patent Application Publication
(10) Pub. No.: US 2008/0252565 A1
(43) Pub. Date: Oct. 16, 2008

(54) Electron emission display device and driving method thereof

(76) Inventors: Dong-hyup Jeon, Suwon-si (KR); Mun-seok Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/081,216

(22) Filed: Apr. 11, 2008

(30) Foreign Application Priority Data
Apr. 12, 2007 (KR) 10-2007-0036061

(51) Int. Cl. G09G 3/20

(52) U.S. Cl. 345/74.1

(57) ABSTRACT

An electron emission display device may include a pixel unit configured to emit electrons from first electrodes in accordance with voltages applied to the first electrodes and second electrodes, a clock generator including first and second lookup tables storing pulse widths of clocks, the clock generator configured to select one of the first and second lookup tables in accordance with polarity signals and to output the clocks, a data driver configured to generate data signals from image signals and the clocks generated from the clock generator, and to transfer the data signals and the clocks to the first electrode, and a scan driver configured to generate scan signals and to transfer the scan signals to the second electrode.

### BACKGROUND OF THE INVENTION

1. Field of the Invention

Embodiments relate to an electron emission display device and a driving method thereof. More specifically, embodiments relate to an electron emission display device and a driving method thereof capable of reducing power consumption, heat generation and picture quality deterioration.

2. Description of the Related Art

A flat panel display device includes a display region having a plurality of pixels arranged on a substrate in the form of a matrix, and displays an image by connecting scan lines and data lines to the respective pixels to selectively apply signals to the pixels. Flat panel display devices include a passive matrix type display device and an active matrix type display device, depending on a driving scheme of a pixel. Active matrix type display devices select and light each unit pixel, and are often favored due to better resolution, contrast, and operation speed, as compared to passive matrix type display devices.

Such flat panel display devices may be used as the display device for numerous applications, including personal computers, portable information terminals, e.g., mobile phones and personal digital assistants, etc., various information devices, and so forth. Flat panel display devices include a liquid crystal display (LCD) using a liquid crystal panel, an organic light emitting display device using an organic light emitting device, a plasma display panel (PDP) using a plasma panel, and an electron emission display device using an electron emission device, etc.

In electron emission display devices, the electrons emitted from the electron emitters on cathode electrodes impact anode electrodes having a high voltage to emit light from a phosphor so that an image is displayed. A gray scale of the displayed image varies depending on the value of an input digital image signal. In order to control the gray scale displayed depending on the value of the input digital image signal, a pulse width modulation scheme can be generally used. The pulse width modulation scheme may include controlling a time period during which a data signal having a predetermined voltage is applied to the cathode electrode. If the time period is long, a high gray scale is displayed and, if the time period is short, a low gray scale is displayed.

The pixels may sequentially emit light for a predetermined time in a horizontal line unit using a line scan scheme. Thus, an entire screen may be displayed, while reducing circuit cost and power consumption. However, the electron emission display device still uses a high voltage, so power consumption is large and heat generation is problematic.

### SUMMARY OF THE INVENTION

Embodiments of the present invention are therefore directed to an electron emission display and a driving method thereof, which substantially overcome one or more of the problems due to the limitations and disadvantages of the related art.

It is therefore a feature of an embodiment to provide an electron emission display device and a driving method thereof capable of reducing power consumption.

It is therefore another feature of an embodiment to provide an electron emission display device and a driving method thereof capable of reducing heat generation.

It is therefore still another feature of an embodiment to provide an electron emission display device and a driving method thereof capable of preventing picture quality deterioration.

At least one of the above and other features and advantages may be realized by providing an electron emission display device, including a pixel unit configured to emit electrons from first electrodes in accordance with voltages applied to the first electrodes and second electrodes, a clock generator including first and second lookup tables storing pulse widths of clocks, the clock generator configured to select one of the first and second lookup tables in accordance with polarity signals and to output the clocks, a data driver configured to generate data signals from image signals and the clocks generated from the clock generator, and to transfer the data signals and the clocks to the first electrode, and a scan driver configured to generate scan signals and to transfer the scan signals to the second electrode.

A pulse width of the clock output by the first lookup table may increase over time. A pulse width of the clock output by the second lookup table may decrease over time.

The data driver may includes a latch configured to serially receive the image signals and to output the image signals in parallel, a counter configured to receive the clocks from the clock generator and to generate count signals in accordance with a number of clocks, a comparator configured to compare a number of image signals output from the latch with the counting signals, and to output the image signals when the number of image signals and the counting signal are the same, and a level shifter configured to output predetermined voltages when the image signals are received from the comparator and to invert the polarity of the predetermined voltage at a predetermined time. The predetermined time is one horizontal synchronizing period.

The electron emission display device may include a timing controller configured to output the polarity signal. A polarity of the polarity signal may be switched once during each horizontal period.

The pulse widths of clocks output by the first lookup table at an end of a period may substantially equal pulse width of clocks output by the second lookup table at a start of a period.

The pixel unit may include a plurality of pixels where the first and second electrodes intersect.

At least one of the above and other features and advantages may be realized by providing a driving method of an electron emission display device displaying an image in accordance with a scan signal and a data signal, and displaying a gray scale by controlling a pulse width of the data signal, the method including selecting one of first and second lookup tables in accordance with a polarity signal, controlling pulse widths of clocks in accordance with the selected lookup table, and controlling the pulse width of the data signal by counting the clocks.

The driving method may include inverting the polarity of the polarity signal once each horizontal synchronizing period. The driving method may include inverting a polarity of driving voltage in accordance with the polarity signal.

Controlling the pulse width of the clock output from the first lookup table may include increasing the pulse width over time. Controlling the pulse width of the clock output from the second lookup table may include decreasing the pulse width over time.

Controlling the pulse width of the data signal may include comparing a number of image signals with the clocks counted, outputting image signals when the number of image signals and the clocks counted are the same, and, when the image signals are output, inverting a polarity of the data signal at a predetermined time. The predetermined time may be one horizontal synchronizing period.

Pulse widths of clocks output by the first lookup table at an end of a period may substantially equal pulse width of clocks output by the second lookup table at a start of a period.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a block diagram of an electron emission display device according to the present invention;

FIG. 2 illustrates a block diagram of a clock generator in the electron emission display device as shown in FIG. 1;

FIG. 3 illustrates a block diagram of a data driver in the electron emission display device as shown in FIG. 1;

FIG. 4 illustrates a timing diagram of signals input/output to/from the electron emission display device according to a first embodiment; and

FIG. 5 illustrates a timing diagram of signals input/output to/from the electron emission display device according to a second embodiment.

### DETAILED DESCRIPTION OF THE INVENTION

Korean Patent Application No. 10-2007-0036061, filed on Apr. 12, 2007, in the Korean Intellectual Property Office, and entitled “Electron Emission Display Device and Driving Method Thereof” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

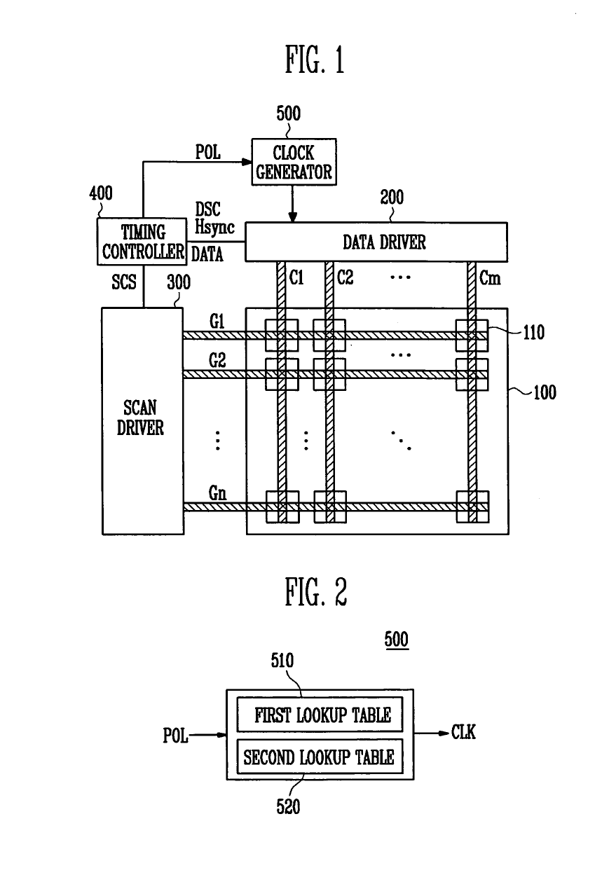

FIG. 1 illustrates a diagram of an electron emission display device according to an embodiment of the present invention. Referring to the FIG. 1, the electron emission display device may include a pixel unit 100, a data driver 200, a scan driver 300, a timing controller 400, and a clock generator 500.

The pixel unit 100 may include pixels 110, each of which may include an electron emitter at corresponding intersections of cathode electrodes C1, C2 . . . Cm and anode or gate electrodes G1, G2 . . . Gn. Electrons emitted from cathode electrodes in the electron emitters may impact the anode electrodes at a high voltage, causing a phosphor to emit light so that an image is displayed. A gray scale of the displayed image may vary in accordance with a value of an input digital image signal.

The data driver 200 may generate data signals using image signals, and may be connected to the cathode electrodes C1, C2 . . . Cm to transfer the data signals to the pixel unit 100 so that the pixels 110 emit light corresponding to the data signals. In order to control the gray scale displayed in accordance with the value of the image signal, the data driver 200 may generally use a pulse width modulation scheme. In the pulse width modulation scheme, a time period during which a data signal having a predetermined voltage is applied to the cathode electrode is controlled. If the time period is long, a high gray scale is displayed. If the time period is short, a low gray scale is displayed. Further, the polarity of the output signal may be inverted at a predetermined time. When the polarity is inverted, a high voltage and a low voltage may be alternately used, so that power consumption may be reduced. Thus, heat generation may be reduced.

The scan driver 300 may generate scan signals, and may be connected to the gate electrodes G1, G2 . . . Gn to transfer the scan signals to the pixel unit 100 so that the pixels 110 may sequentially emit light by a predetermined time in a horizontal line unit using a line scan scheme. The line scan scheme allows the entire screen to be displayed, while reducing circuit cost and power consumption.

The timing controller 400 may output an image signal DATA, a blank signal BLK, a horizontal synchronizing signal Hsync, a vertical synchronizing signal Vsync, a polarity signal POL, a data driver control signal DSC, and a scan driver control signal SCS, etc. The scan driver control signal SCS may be output to the scan driver 300. The image signal DATA, the horizontal synchronizing signal Hsync, and the data driver control signal DSC may be output to the data driver 200.

The clock generator 500 may receive the polarity signal POL having alternating positive and negative signals, and may generate different clocks in accordance with the positive and negative signals. The clock generator 500 may output these different clocks to the data driver 200, thereby controlling the pulse width of the data signal output from the data driver 200. The polarity of the polarity signal POL may be inverted once each horizontal period.

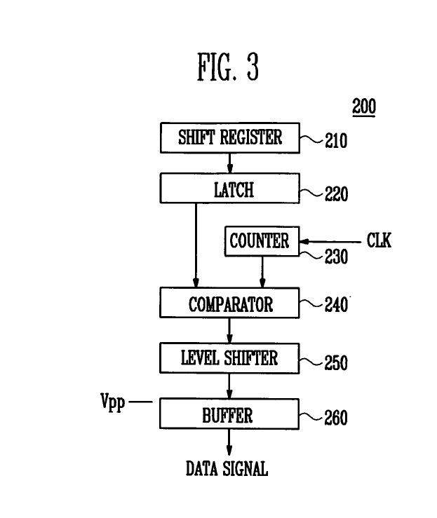

FIG. 2 illustrates a block diagram of the clock generator 500 in the electron emission display device as shown in FIG. 1 in accordance with an embodiment. Referring to the FIG. 2, the clock generator 500 may include first and second lookup tables 510 and 520, to be selected by the polarity signal POL. Information regarding the pulse width of the clock may be stored in the first and second lookup tables 510 and 520. When the polarity signal POL is negative, the first lookup table 510 may be selected and, when the polarity signal POL is positive, the second lookup table 520 may be selected. The first lookup table 510 may increase pulse width over time, while the second lookup table 520 may decrease pulse width over time.

FIG. 3 illustrates a block diagram of the data driver 200 in the electron emission display device as shown in FIG. 1 in accordance with an embodiment. Referring to the FIG. 3, the data driver 200 may include a shift register 210, a latch 220, a counter 230, a comparator 240, a lever shifter 250, and a buffer 260.

The shift register 210 may serially receive eight-bit image signals and transfer the image signals to the latch 220. The latch 220 may output the serially input eight-bit image signals in parallel and transfer them to the comparator 240. The counter 230 may receive clocks from the clock generator 500 and count them from 0 to 255. Since the clocks stored in the first and second lookup tables 510 and 520 have varying pulse widths with time, a number of clocks generated by the clock generator 500 may be different at the same time within an interval depending on the polarity signal POL, e.g., based on the first or second lookup table 510, 520. The comparator 240 may compare the number of the image signals from the latch 220 with the number of the clocks counted by the counter 230, and may output the image signals when the gray scale value of the image signals agrees with the number counted.

The image signals output from the comparator 240 may be transferred to the buffer 260 via the level shifter 250, which may, in turn, output the data signals. The level shifter 250 may invert the voltage levels of the output signals depending on the voltage level of the polarity signal. In other words, during a first horizontal period, when the signal is input from the comparator 240, the voltage of the output signal may switch from a low state to a high state. In a second horizontal period, when the signal is input from the comparator 240, the voltage of the output signal may switch from a high state to a low state.

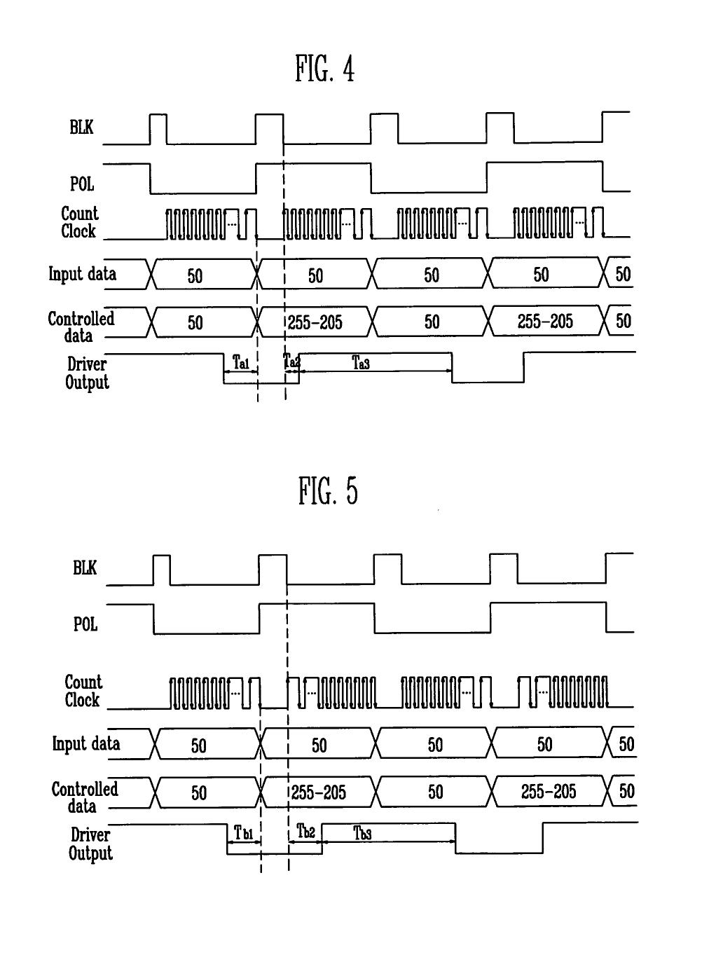

FIG. 4 illustrates a timing diagram of signals input/output to/from the electron emission display device according to a first embodiment of the present invention. In the particular example illustrated in FIG. 4, an image signal indicates that fifty gray scales may be displayed. The pulse width of the clock may originally be narrow and may increase over time in order to provide good visibility for a low gray scale. The blank signal BLK is input once per horizontal period. When a first blank signal BLK is input, the polarity signal POL becomes negative and, when a second blank signal BLK is input, the polarity signal POL becomes positive, i.e., inverts its polarity. When a third blank signal BLK is input, the polarity signal POL again becomes negative by again inverting its polarity. The polarity of the polarity signal POL may thus be inverted once per horizontal period.

Referring to the FIG. 4, first, an interval in which the polarity signal POL is negative will be described. The level shifter 250 may maintain a high state due to the negative polarity signal POL. The counter 230 may count clocks after the blank signal BLK has been received. The comparator 240 may compare the gray scale value of the image signal with the counted number from the counter 230 and may output the signal to the level shifter 250 when fifty has been counted. The output of the level shifter 250 may switch from the high state to the low state when the signal is input from the comparator 240, and the driver output may be maintained at the low state during one horizontal time period, i.e., the time of Ta1, and fifty gray scales may be displayed during the time of the Ta1.

Now, an interval in which the polarity signal POL is positive will be described. The level shifter 250 may remain in the low state due to the polarity signal POL. The counter 230 may count clocks after the blank signal BLK has been received. The comparator 240 may compare the gray scale value of the image signal with the counted number and may output the signal to the level shifter 250 when fifty has been counted. The output of the level shifter 250 may switch to a high state when the image signals are received from the comparator 240. Accordingly, the driver output may be low during time Ta2, and high during time Ta3. Therefore, fifty gray scales may be displayed during time Ta2.

Since the pulse width of the clock is originally narrow at the beginning of an interval and increases over time in the embodiment illustrated in FIG. 4, time Ta1 is longer than time Ta2. Accordingly, although the same fifty gray scales are input, a light emitting time in the first and second periods are different, causing a difference in brightness by line.

FIG. 5 illustrates a timing diagram of a signal input/output to/from the electron emission display device according to a second embodiment of the present invention. An image signal indicates that fifty gray scales may be displayed. The clock generator 500 may provide clocks having varying pulse widths in accordance with the first and second lookup tables 510 and 520. For example, the pulse width of the clock generated by the first lookup table may originally be narrow and may increase over time, and the pulse width of the clock generated by the second lookup table may originally be wide and may decrease over time. The blank signal BLK may be input once per horizontal time period. When the first blank signal BLK is input, the polarity signal POL may be maintained at a negative signal. When the second blank signal BLK is input, the polarity signal POL may be maintained at a positive signal, i.e., invert its polarity. When the third blank signal BLK is input, the polarity signal POL may be again maintained at the negative signal by again inverting its polarity. The polarity of the polarity signal POL may thus be inverted once per horizontal time period.

Referring to the FIG. 5, first, an interval in which the polarity signal is the negative signal will be described. The level shifter 250 may be maintained in the high state due to the polarity signal POL. The counter 230 may count clocks after the blank signal BLK has been received. The comparator 240 may compare the gray scale value of the image signal with the counted number and may output the signal to the level shifter 250 when fifty has been counted. The output of the level shifter 250 may switch from the high state to the low state when the signal is received from the comparator 240, and the driver output may be maintained at the low state during one horizontal time period, i.e. time Tb1, and fifty gray scales may be displayed during the time Tb1.

Now, an interval in which the polarity signal POL is the positive signal will be described. The level shifter 250 may be maintained in the low state due the polarity signal POL. The counter 230 may count clocks after the blank signal BLK has been received. The comparator 240 may compare the gray scale value of the image signal with the counted number and may output the image signals to the level shifter 250 when fifty has been counted. The output of the level shifter 250 may switch to the high state when the image signals are received from the comparator 240. Accordingly, the driver output may be low during time Tb2, and high during time of Tb3. Therefore, fifty gray scales may be displayed during time Tb2.

Therefore, according to the second embodiments, in the interval in which the polarity signal is maintained negative, the pulse width of the clock may originally be narrow and may increase over time and, in the interval in which the polarity signal is maintained positive, the pulse width of the clock may originally be wide and may decrease over time, so that times Tb1 and Tb2 may be closer in value. Accordingly, when the same fifty gray scales are input, the times of light emitting are more similar, so that the difference in brightness may be reduced or prevented. In other words, pulse widths at the end of an interval during which the polarity signal is maintained negative may be made substantially equal to pulse widths at the beginning of a next interval during which the polarity signal is maintained positive.

The electron emission display device and the driving method thereof according to embodiments may reduce power consumption and heat generation. Further, difference in brightness between lines may be reduced so that picture quality deterioration may be reduced or prevented.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electron emission display device, comprising:
a pixel unit configured to emit electrons from first electrodes in accordance with voltages applied to the first electrodes and second electrodes;
a clock generator including first and second lookup tables storing pulse widths of clocks, the clock generator configured to select one of the first and second lookup tables in accordance with polarity signals and to output the clocks;
a data driver configured to generate data signals from image signals and the clocks generated from the clock generator, and to transfer the data signals and the clocks to the first electrode; and
a scan driver configured to generate scan signals and to transfer the scan signals to the second electrode.

2. The electron emission display device as claimed in claim 1, wherein a pulse width of the clock output by the first lookup table increases over time.

3. The electron emission display device as claimed in claim 1, wherein a pulse width of the clock output by the second lookup table decreases over time.

4. The electron emission display device as claimed in claim 1, wherein the data driver includes:
a latch configured to serially receive the image signals and to output the image signals in parallel;
a counter configured to receive the clocks from the clock generator and to generate count signals in accordance with a number of clocks;
a comparator configured to compare a number of image signals output from the latch with the counting signals, and to output the image signals when the number of image signals and the counting signal are the same; and
a level shifter configured to output predetermined voltages when the image signals are received from the comparator and to invert the polarity of the predetermined voltage at a predetermined time.

5. The electron emission display device as claimed in claim 4, wherein the predetermined time is one horizontal synchronizing period.

6. The electron emission display device as claimed in claim 1, further including a timing controller configured to output the polarity signal.

7. The electron emission display device as claimed in claim 6, wherein a polarity of the polarity signal is switched once during each horizontal period.

8. The electron emission display device as claimed in claim 1, wherein pulse widths of clocks output by the first lookup table at an end of a period substantially equal pulse widths of clocks output by the second lookup table at a start of a period.

9. The electron emission display device as claimed in claim 1, wherein the pixel unit includes a plurality of pixels where the first and second electrodes intersect.

10. A driving method of an electron emission display device displaying an image in accordance with a scan signal and a data signal, and displaying a gray scale by controlling a pulse width of the data signal, the method comprising:
selecting one of first and second lookup tables in accordance with a polarity signal;
controlling pulse widths of clocks in accordance with the selected lookup table; and
controlling the pulse width of the data signal by counting the clocks.

11. The driving method of an electron emission display device as claimed in claim 10, further comprising inverting the polarity of the polarity signal once each horizontal synchronizing period.

12. The driving method of an electron emission display device as claimed in claim 10, further comprising inverting a polarity of driving voltage in accordance with the polarity signal.

13. The driving method of an electron emission display device as claimed in claim 10, wherein controlling the pulse width of the clock output from the first lookup table includes increasing the pulse width over time.

14. The driving method of an electron emission display device as claimed in claim 10, wherein controlling the pulse width of the clock output from the second lookup table includes decreasing the pulse width over time.

15. The driving method of an electron emission display device as claimed in claim 10, wherein controlling the pulse width of the data signal includes:
comparing a number of image signals with the clocks counted;
outputting image signals when the number of image signals and the clocks counted are the same; and
when the image signals are output, inverting a polarity of the data signal at a predetermined time.

16. The driving method of an electron emission display device as claimed in claim 15, wherein the predetermined time is one horizontal synchronizing period.

17. The driving method of an electron emission display device as claimed in claim 10, wherein pulse widths of clocks output by the first lookup table at an end of a period substantially equal pulse widths of clocks output by the second lookup table at a start of a period.
